(19) United States
(12) Patent Application Publication
(10) Pub. No.: US 2014/0345293 A1
(43) Pub. Date: Nov. 27, 2014

(54) High Performance Energy Storage System Using Carbon Dioxide

(71) Applicants: Iván RAISZ, Felsözsolca (HU); Dávid RAISZ, Budapest (HU)

(72) Inventors: Iván RAISZ, Felsözsolca (HU); Dávid RAISZ, Budapest (HU)

(21) Appl. No.: 14/285,858

(22) Filed: May 23, 2014

(30) Foreign Application Priority Data
May 23, 2013 (HU) P1300330

(51) Int. Cl. F02C 6/14

(52) U.S. Cl. CPC F02C 6/14
USPC 60/780; 60/39.461

(57) ABSTRACT

Disclosed is a system suitable for both of the production of electricity, and the utilization of electricity, comprising: electricity transformator, rectifyer, an oxygen storage and drawer unit, a hydrogen gas transmission unit, a reactor for the production of methanol, to which a carbon dioxide container and a carbon dioxide compression and pre-heating unit is linked at the input side, and a methanol-water rectifying unit is linked at the output side, the water leaving said rectifying unit is transferred to the fresh water inlet, and the separated methanol is transferred to the methanol storage tank, which is optionally linked to an equipment suitable for the combustion of methanol, preferably gas turbine. A process for storing electricity using the system is also disclosed.

### THE TECHNICAL PROBLEM ACCORDING TO THE PRESENT INVENTION

Electricity producers (with the exception of base load power plants) run quite often into the problem that at off-peak and super off-peak times the electricity cannot or only at extremely low prices be sold. (It may even occur that in order to ensure the plant safety of the energy suppliers, some power plants have to produce electricity, and the excess should be sold abroad, eventually at negative price.) At peak times on the other hand, loads higher than the optimal level should be used for economical and environmental reasons.

The amount of electricity obtained from renewable energy sources depends from the actual condition of the environmental factors, and does not fit the demands of electricity. In order to solve both of said problems, in Hungary several 10 MWs of storage capacities would be needed, furthermore, said storage systems should be of no saturation limits (unlike e.g. in case of conventional lead batteries.)

### BRIEF DESCRIPTION OF THE INVENTION

The process according to the present invention is based on producing hydrogen gas in a pressurized alkaline water electrolysis equipment using the cheaper electricity produced at off-peak and super off-peak times, and the hydrogen produced is converted into methanol without storing and changing of the pressure, using the available liquid carbon dioxide. The carbon dioxide raw material, which has been captured from flue gas of power plants to decrease the greenhouse effect and the liquid methanol can both be stored and transported without risk.

The produced methanol can be converted into electricity at the desired place and time in a co-generation system by making use of the heat. The oxygen produced as a by-product during the electrolysis makes it unnecessary to use significant electric powers for the production of oxygen.

The electricity produced by wind and solar power stations may similarly be stored, and thus the unsteady and weather-dependent production of the renewable energy sources becomes available for the electricity system in a steady and predictable way.

The process helps the widespread utilization of the electricity produced periodically from renewable energy sources, thus significantly decreasing of the environmental burden of electricity production.

### DESCRIPTION OF THE STATE OF THE ART

W. Stahl, K. Voss and A. Goetzberger describe a house provided with solar cells with 2 kW electrical capacity (Solar Energy, Volume 52 p. 111-125.), where the hydrogen and oxygen obtained by the electrolysis using the energy of the solar cell are stored and the electricity is then obtained from the gases in a fuel cell. The fuel cell operates with significant loss of energy, and the hydrogen is stored at 30 bar pressure until its use.

Duke Energy Renewables established a 36 MW storage capacity made from acidic lead batteries in Notrees. The batteries can be loaded for 15 minutes period of time, then only consumption can take place. Efforts are made for the production of solid electrolyte batteries, which may be recycled to 95%.

Another widespread opportunity is the application of fuel cells. This certainly implies significant loss both in the converting and in the re-converting of the electricity and the materials. Today the efficiency of the industrial scale fuel cells is around 40% (Ballard model with 63 kg of hydrogen; 1 MW electric performance without the opportunity of the utilization of heat), this may be developed until 65% in the coming years. The storage cost and energy of the hydrogen serving as fuel is, however, important: at 350-700 bar pressures composite tanks are used. There is no opportunity for the internal heat exchange, therefore the use said tanks are not advisable with higher amounts. The cost of the storage capacity is 500-600 USD/kg H. Its energetic cost is more favourable than the non-gas phase hydrogen storage, however, the compression loss may even be 40%. The storage and fuel cell loss together may thus exceed 70%.

As a big drawback of the preparation of hydrogen from fossils George Olah mentions the significant amount of carbon dioxide emitted (George Oláh György, Alain Goeppert, G. K. Surya Prakash: K [symbol] olaj és földgáz után: a metanol gazdaság. Better Kiadó Budapest 2007 p. 168), for which “not any known separation and reception technology have so far been adopted for industrial scale application”.

Also George Olah is the author, who consistently mentions the common reaction of CO and CO₂ with hydrogen at the hydrogen based preparation of methanol. (George Oláh, Alain Goeppert, G. K. Surya Prakash: K [symbol] olaj és fóldgáz után: a metanol gazdaság. Better Kiadó Budapest 2007 p. 260).

### BRIEF DESCRIPTION OF THE DRAWINGS

FIG. 1 is a flowchart of the energy storage system.

FIG. 2 shows hydrogen pre-treatment for methanol synthesis.

FIG. 3 shows carbon dioxide pre-treatment for methanol synthesis.

FIG. 4 shows rectification of methanol-water mixture.

### THE DISCOVERY ACCORDING TO THE PRESENT INVENTION

The present process is based on the discovery that the liquid carbon dioxide presenting economical burden in the CCS (CO₂ capture and storage) process, and elemental hydrogen obtainable from excess electricity (without the storage thereof) are suitable for the preparation of liquid methanol with practically no limitation in amount, after an appropriate pre-treatment, within 300 seconds counted from the starting of the system. The methanol may produce electricity and the accompanying heat energy by the use of gas turbine and/or methanol motor at the desired place and time. The pure oxygen produced as by-product presents a quasi-energy source for the reason of its significant production energy content, and it can be used for conventional industrial purposes or in OXYFUEL technologies as air-free combustion additive in power plants without additional energy consumption.

Comparison of the off-peak (the cheapest 8 hours) and the peak (the most expensive 8 hours) wholesale electricity prices points out to the business opportunities carried by the present process as shown by Table 1.

TABLE 1
Average prices and their proportion within one day

| | 1 week HUPX prices [symbol] /MWh | | | | | | |
|---|---|---|---|---|---|---|---|
| | Sunday, | Monday, | Tuesday, | Wednesday, | Thursday, | Friday, | Saturday, |
| | 04/07 | 04/08 | 04/09 | 04./10 | 04/11 | 04/12 | 04/13 |
| Average price | 22.89 | 34.13 | 37.19 | 34.96 | 37.87 | 33.69 | 18.53 |
| of the cheapest | | | | | | | |
| 8 hours | | | | | | | |
| Average price | 39.49 | 80.23 | 69.20 | 69.40 | 73.62 | 63.08 | 38.70 |
| of the most | | | | | | | |
| expensive 8 | | | | | | | |
| hours | | | | | | | |
| Proportion | 1.72 | 2.35 | 1.86 | 1.99 | 1.94 | 1.87 | 2.09 |
| Average price of | 6 868 | 10 238 | 11 158 | 10 488 | 11 361 | 10 105 | 5 558 |
| the cheapest 8 | | | | | | | |
| hours, HUF/MWh | | | | | | | |

The situation seems to be even more convincing, if it is considered from point of view of utilization as secondary control emergency (Table 2).

TABLE 2
Secondary control emergency prices
Based on the 2012 data of MAVIR, the
prices paid for the secondary control:

| Secondary up | | Secondary down | |
|---|---|---|---|
| Capacity price | Energy price | Capacity | Energy price |
| [HUF/MW/h] | [HUF/MWh] | price [HUF/MW/h] | [HUF/MWh] |
| 12 358.0 | 56 354.0 | 11 951.0 | 758.0 |

For the above reasons the present system had to be configured in such a way that the system be suitable both to consume, and to produce electricity within a couple of minutes. The electricity input is provided through a transformer and rectifier system in an alkaline water electrolysis system. This system may be configured using a number of alternatives, preferably, considering the further technological steps, we selected a 30 bar pressure system. The specific parameters of the performance vary, the systems with higher capacity are characterized by 4.1-4.35±0.1 kWh/Nm³H₂ (NEL A system), and taking into consideration the consumption of the auxiliary systems, said high performance systems provide 99.9% purity hydrogen in a 200 kg/h amount at 30 bar pressure (which is considered to be the unit of production) at 10.5 MW performance. Besides hydrogen, 1600 kg/h 99.5% purity oxygen is produced at 30 bar pressure.

With the help of the separate heat storage unit, the 210° C. temperature of the conventional methanol reactor can be achieved within 5 minutes, and through the energy consumption of the hydrogen producing unit the methanol production starts, and the energy is stored in the form of the production heat of methanol. The reaction components are continuously heated with the help of the reaction heat and the condensation heat. The steam of the methanol and water mixture is separated in a rectifying column through selective condensation, and only cooling water is needed, without separate heating.

Characterization of the Process and Material Stream of the Technology

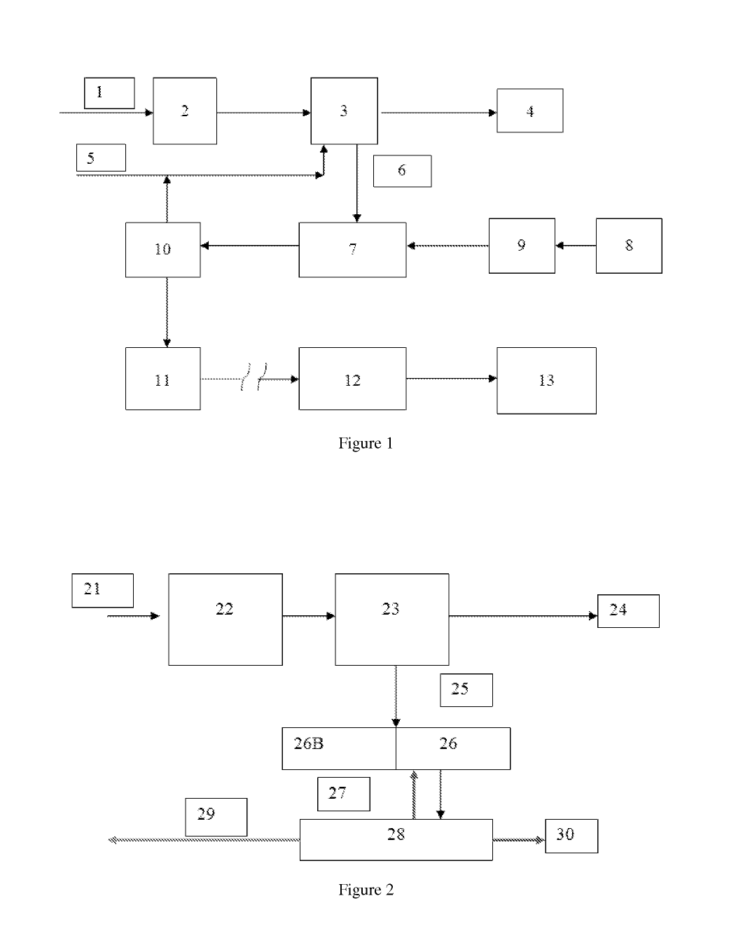

The major elements of the process are illustrated by FIG. 1. Using the electricity of the 1 input from the electric network, the 2 transformer and rectifier unit provides the production of 6 hydrogen in the 3 alkaline water electrolysis system, said hydrogen is led to the 7 reactor after pre-treatment. 4 oxygen, produced through the electrolysis, is led to the storage tank. The water supply of the water electrolysis system is provided by the fresh water obtained from the 5 water pre-treatment unit and the return water leaving the 10 methanol-water rectifying unit together. The other reaction component, carbon dioxide used besides hydrogen for the preparation of methanol in the methanol reactor is provided from the 8 liquid carbon dioxide container, using the 9 compression and heating unit. The methanol and water mixture produced in the 7 methanol reactor is separated in the 10 rectifying unit, from where the methanol is transferred to the 11 methanol container.

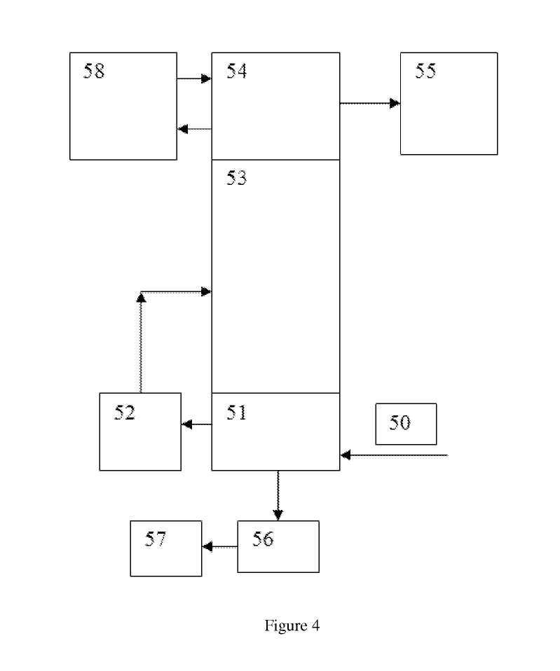

The details of the hydrogen preparation and pre-treatment can be seen in FIG. 2. After the 21 network inlet and 22 rectification, the oxygen produced in the 23 electrolysis unit is transferred to the 24 oxygen storage tank. The 25 hydrogen stream at 30 bar pressure is led to the 26 heat exchanger, where, using a part of the 27 reaction heat of methanol, said hydrogen is heated to 210° C. temperature. In the period of the quick start in the 26B part of the pre-heating unit the accelerated heating of the gas stream is provided by molten tin. The methanol-water system produced in the 28 methanol reactor is transferred to the 29 methanol-water rectifying system. This is detailed in FIG. 4. A part of the produced 30 heat is used for the pre-heating of carbon dioxide.

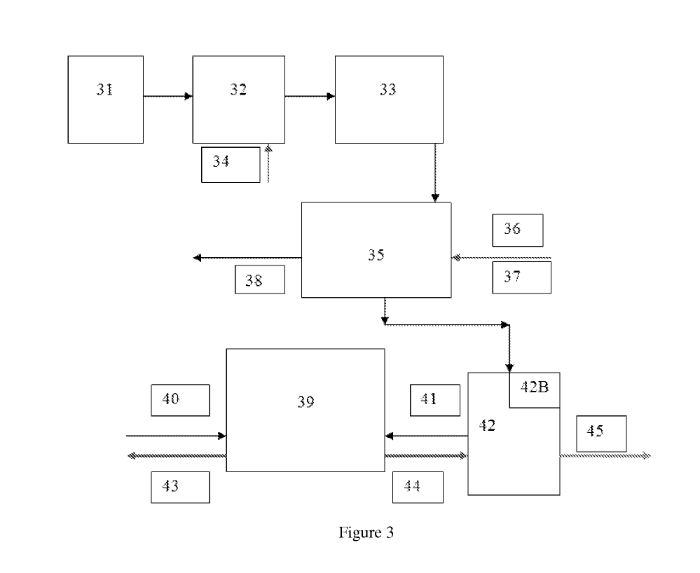

The preparation of carbon dioxide is a more complex process, which can be seen in FIG. 3. In general, the material in the 31 liquid carbon dioxide storage tank is at 19 bar pressure and −24° C. temperature. First, the pressure of carbon dioxide should be elevated to 30 bar, using the 32 carbon dioxide compressor, which is stored in the 33 intermediary tank. Then the carbon dioxide is heated by maintaining 30 bar pressure in the 35 lamellar heat exchanging unit, with the use of the ambient air, applying the 37 blower. The significant amount of 38 cold energy may be used at other points of the system. Heating to 210° C. takes place in the 42 heat exchanger in a continuous operation, partially using the 44 reaction heat of methanol. In the phase of accelerated start molten tin ensures the fast heating of the gas stream in 42B part of the pre-heater. The such prepared 41 carbon dioxide is led to the 39 methanol reactor, to where 40 hydrogen is also supplied. The reactor is pre-heated by the 43 partial methanol-water stream. In the 42 heat-exchanger the partially cooled methanol-water mixture is led to the rectifying system along the 45 line.

The separation of the methanol-water mixture is illustrated in FIG. 4. For this purpose, the 53 rectifying column is used. The 50 liquid mixture of 170° C. temperature, but of 30 bar pressure, used partly for the heating of hydrogen, partly for the heating of carbon dioxide, is used for maintaining of the 102° C. temperature of the boiler, then it is expanded to 1.2 bar pressure using the 52 expansion valve. The steam-liquid mixture is led to the rectifying column, while leading the methanol steams to the reflux cooler, where it condenses by the help of the 58 cooling water stream, and the produced 55 methanol is lead at 1.1 bar pressure off. The 56 pure water leaving the boiler is fed back to the 57 electrolysing system.

Obtaining of the electricity is solved by using the produced methanol in the 12 gas turbine.

### LEGEND FOR FIGURES

1 Input from the electric network
2 Transformer and rectifier unit
3 Alkaline water electrolysis system
4 Oxygen storage tank, outlet
5 Fresh water feeding
6 Hydrogen transfer to the methanol reactor
7 Methanol reactor
8 Carbon dioxide storage tank
9 Carbon dioxide compression, pre-heater
10 Rectification of methanol-water mixture
11 Methanol container
12 Gas turbine
13 Generated electricity and thermal energy
21 Input from the electric network
22 Transformer and rectifier unit
23 Alkaline water electrolysis system
24 Oxygen storage tank, outlet
25 Hydrogen transfer to the methanol reactor
26 Hydrogen gas pre-treatment
26B Melted tin initial pre-heater
27 Heat transfer from the methanol reactor
28 Methanol reactor
29 Rectification of methanol-water mixture
30 Heat transfer to carbon dioxide heater
31 Liquid nitrogen storage tank, at pressure of 19 bar
32 Liquid carbon dioxide compressor
33 Liquid carbon dioxide storage tank, at pressure of 30 bar, at temperature of −24° C.
34 Compressor energy input
35 Liquid carbon dioxide storage tank at pressure of 30 bar, at temperature of −6° C.
36 Ambient air
37 Blower
38 Cold air for system cooling
39 Methanol reactor
40 Hydrogen feeding
41 Carbon dioxide feeding
42 Continuous carbon dioxide preheater
42B Melted tin initial carbon dioxide preheater
43 Heat transfer to hydrogen preheater
44 Heat transfer to carbon dioxide preheater
45 Methanol-water mixture for rectifying
50 Methanol-water mixture from the methanol reactor after heat exploitation at temperature of 170° C., at pressure of 30 bar
51 Boiler unit at temperature of 102° C.
52 Expansion valve at pressure of 1.2 bar
53 Rectifying column
54 Reflux cooler and spreader
55 Methanol outlet at temperature 45° C., at pressure of 1.1 bar
56 Distilled water outlet
57 Recycled water for water electrolysis
58 Condenser cooling

Accordingly, the present invention relates to the following.

1. The invention in its first aspect relates to a system suitable for both of the production of electricity, and the utilization of electricity, which can flexibly be switched between said functions, and can be started within a couple of minutes, said system comprising the following elements: electricity input (1) transformer-rectifier unit (2), which lead to an alkaline water electrolysing (decomposing) equipment (3) linked to a fresh water inlet (5), an oxygen storage and drawer unit (4) linked to the water electrolysis equipment (3), a hydrogen gas transmission unit (6) linked to the water electrolysis equipment (3), a reactor for the production of methanol (7), to which a carbon dioxide storage tank (8) and a carbon dioxide compressing and pre-heating unit (9) is linked at the input side, and a methanol-water rectifying unit (10) is linked at the output side, the water leaving said rectifying unit (10) is transferred to the fresh water inlet (5), and a unit that enables the separated methanol to be transferred to the methanol storage tank (11), which is optionally linked to an equipment suitable for the combustion of methanol, preferably gas turbine.

2. In a preferred embodiment, the invention relates to the system according to Point 1, which may be switched between the electricity production and the electricity consumption functions, and/or started within less than 1 hour, preferably approximately 5 minutes.

3. In a preferred embodiment, the invention relates to the system according to Point 1 or 2, in which the water electrolysis takes place at approximately 30 bar pressure.

4. In a preferred embodiment, the invention relates to the system according to Points 1 to 3, in which the reactor for the preparation of methanol (7) is equipped with a heat exchange unit, such that said heat storage unit can provide the 210° C. reactant temperature necessary for the production of methanol within 1 hour, preferably in approximately 5 minutes, and can store the production heat of methanol.

5. In a preferred embodiment, the invention relates to the system according to Points 1 to 4, in which the reactor for the preparation of methanol (7) is equipped with a heat exchange unit, such that said heat storage unit can provide the heat transfer for the heating of carbon dioxide.

6. In a preferred embodiment, the invention relates to the system according to Points 1 to 5, in which the alkaline water electrolysing (decomposing) equipment (3) further comprises the following elements: hydrogen gas preparing unit (26), molten tin starting pre-heater (26B), heat transfer from the methanol reactor (27), wherein the hydrogen gas preparing unit (26) receives the heat needed for its operation from the methanol reactor (7, 28).

7. In a preferred embodiment, the invention relates to the system according to Points 1 to 6, in which the carbon dioxide storage tank (8) and the carbon dioxide compressing and pre-heating unit (9) further comprises the following elements: a liquid carbon dioxide storage tank (31), a liquid carbon dioxide compressing unit (32), an intermediary tank (33) for storing the carbon dioxide with elevated pressure, a lamellar heat-exchanging unit (35), a blower (37) for the heating of carbon dioxide, and a carbon dioxide pre-heating unit with continuous operation (42), and a molten tin starting carbon dioxide pre-heating unit (42B) placed within said carbon dioxide pre-heating unit.

8. In a preferred embodiment, the invention relates to the system according to Points 1 to 7, in which the methanol-water mixture separation unit (10) comprises the following: rectifying column (53), boiler (51), expansion valve (52) and reflux cooler and distributor (54).

9. In its second aspect the invention relates to a process for storing electricity, wherein the following steps are taken:

a) the electricity is produced by a method known in itself;

b) hydrogen gas is produced using electricity by a method known in itself, preferably by water electrolysis;

c) if needed, carbon dioxide, preferably carbon dioxide obtained as a by-product from the combustion of fossils is pre-treated, and said carbon dioxide is reacted with the hydrogen gas prepared in step b) to produce methyl alcohol;

d) the methyl alcohol-water mixture is separated without using external heat source;

e) optionally the product according to step c) is combusted, preferably using gas turbine or combustion engine, thus electricity is produced;

f) optionally the oxygen gas produced in the reaction according to step c) is captured and thus electricity is saved.

10. In a preferred embodiment, the invention relates to the process according to Point 9, in which in step a) the electricity used is that part of the produced electricity, which cannot be used, or cannot be used economically in the electric energy system.

11. In a preferred embodiment, the invention relates to the process according to Points 9 to 10, in which the water electrolysis is performed such that the gas produced has approximately 30 bar pressure.

12. In a preferred embodiment, the invention relates to the process according to Points 9 to 11, in which the following steps are taken:

a) using the electricity of the electric network inlet (1), with the help of a transformer rectifier unit (2), hydrogen (6) is produced in an alkaline water electrolysis system;

b) the hydrogen is led to the methanol reactor (7) after pre-treatment;

c) the oxygen (4) produced in the electrolysis resulting in water decomposition is led to a storage tank;

d) the water supply of the water electrolysis system is ensured together by the fresh water obtained from the water pre-treatment unit (5) and the return water leaving the methanol-water rectifying unit (10);

e) in the methanol reactor carbon dioxide, the other reactant besides hydrogen, is supplied from liquid carbon dioxide storing unit (8) using a compressing and heating unit (9);

f) the methanol-water mixture produced in the methanol reactor (7) is separated in the rectifying unit, from where the methanol is transferred to the container (11).

13. In a preferred embodiment, the invention relates to the process according to Points 9 to 12, in which in the production and pre-treatment of hydrogen the following steps are taken:

a) after the electric network supply (21) and rectification (22) the produced oxygen is led from the electrolysis unit to the oxygen storing unit (24);

b) the hydrogen stream (25) produced in the water electrolysis is led to the heat exchanger (26) at a pressure of 30 bar, where, using a part of the methanol reaction heat (27), said hydrogen is heated to 210° C. temperature;

c) in the phase of the accelerated start the fast heating of the gas stream is ensured by molten tin in the (26B) part of the pre-heating unit;

d) the methanol-water system produced in the methanol reactor (28) is transferred to the methanol-water rectifying system; and optionally

e) a part of the heat generated (30) is used for the pre-heating of the carbon dioxide.

14. In a preferred embodiment, the invention relates to the process according to Points 9 to 13, in which in the carbon dioxide pre-treatment the following steps are taken:

a) the pressure of carbon dioxide stored in the liquid carbon dioxide storage tank (31), preferably at a pressure of 19 bar and at −24° C. is increased to approximately 30 bar, preferably using liquid carbon dioxide compressor;

b) if needed, the carbon dioxide with increased pressure is stored in the intermediary tank (33) for indefinite period of time;

c) the carbon dioxide is heated preferably to a temperature of −6° C., preferably in a lamellar heat exchanger unit (35), with the use of the ambient air and preferably with a blower (37), while maintaining the pressure of 30 bar;

d) if needed, the cold energy (38) is used in other points of the system;

e) in the phase of the accelerated start the fast heating of the gas stream is ensured by molten tin in the (42B) part of the pre-heating unit;

f) the carbon dioxide is heated to the temperature of 210° C. in the heat exchanger (42), in continuous operation, using a part of the reaction heat of methanol (44);

g) the pre-treated carbon dioxide is led to the methanol reactor (39), to where hydrogen is also fed (40);

h) if needed, the carbon dioxide is pre-heated with partial methanol-water stream (43), and in the heat exchanger (42) the partially cooled methanol-water mixture is led to the rectifying system.

15. In a preferred embodiment, the invention relates to the process according to Points 9 to 14, in which in the separation of the methanol-water mixture the following steps are taken:

a) with the liquid mixture (50) used in part for the pre-heating of hydrogen, in part for the pre-heating of carbon dioxide, said liquid mixture cooled to 170° C., but being of 30 bar pressure, the temperature of the boiler (51) is maintained at 102° C., then it is expanded to 1.2 bar pressure using the expansion valve (52)

b) leading the steam-liquid mixture to the rectifying column (53), the metanol steams are led to the reflux cooler (54), where with the help of the stream of the cooling water (58) it is condensed, and the produced methanol (55) is led at a pressure of 1.1 bar off;

c) the pure water leaving the boiler (56) is fed back the electrolysing system (57).

16. In a preferred embodiment, the invention relates to the process according to Points 9 to 15, in which in the pre-treatment of hydrogen gas, at the starting phase of the system's operation, the temperature of methanol needed in the reactor, preferably 210° C. is ensured by the use of a heat exchanger containing molten tin (26B), while in the continuous operation said temperature is ensured by the use of the reaction heat of methanol (26).

Accordingly, the process according to the present invention makes the following possible:

1. A process for the storing of 1 electricity, in which hydrogen gas is developed from the part of the produced electricity, which cannot be used, or cannot be used economically in the electric energy system in 3 an alkaline water electrolysis unit, and said hydrogen is converted into the risk-free storable 11 liquid methyl alcohol without its storing, using the 8 liquid carbon dioxide produced as a by-product in the CCS systems, said methyl alcohol may be consumed at the place and time of the electricity consumption by the converting thereof into 13 electricity by the use of a 12 gas turbine or in a combustion engine. At the same time with the industrial use of the 4 oxygen produced as a by-product besides methanol, which otherwise contains considerable amount of production energy, electric energy saving can be achieved.

2. In the above process, in the 3 alkaline water electrolysis system gases with high pressure, advantageously of 30 bar pressure are produced.

3. In the above process the temperature of the hydrogen in the 26 pre-treatment unit needed in the methanol reactor, preferably 210° C. is ensured by the 26B heat exchanger containing molten tin at the accelerated start of the system, and by the 26 heat exchanger using the reaction heat of methanol in the continuous operation.

4. In the above process during the pre-treatment of carbon dioxide, the liquid carbon dioxide preferably at 19 bar pressure and at −24° C. temperature is compressed to preferably 30 bar pressure from the 31 storage tank by the 32 compressor, then using the 36 ambient air said carbon dioxide still in the liquid state is heated preferably to −6° C. in the 35 heat exchanger. The 38 cold air stream is used for cooling. Then the temperature needed in the methanol reactor, preferably 210° C. is ensured by the 42B heat exchanger containing molten tin at the accelerated start of the system, and by the 42 heat exchanger using the reaction heat of methanol in the continuous operation.

5. In the above process, in the 39 methanol reactor methanol-water mixture is produced preferably at 30 bar pressure and at 210° C. temperature, using hydrogen and carbon dioxide gases. A part of the reaction heat are used for the pre-heating of the reaction components in the 43 and 44 fluid streams, other part of said reaction heat is used for the production of electricity in ORC (organic Rankine cycle) system, then the methanol-water mixture is separated in the 53 rectifying column, and the thermal energy of the reaction product mixture is used for the heating of the 51 boiler.

6. In the above process at the output of the high performance battery, the stored electricity and thermal energy is obtained in co-generation mode and fed back into the supplying system by the use of a 12 gas turbine or an alternative technical equipment, consuming the methanol stored in the 11 methanol storage unit and its transporting systems.

### EXAMPLE

In the system the alkaline electrolysis system is filled with water purified by reverse osmosis. The oxygen storage and drawer system is flushed with oxygen of atmospheric pressure. The liquid carbon dioxide tank is filled until the prescribed level with liquid carbon dioxide of 19 bar pressure and −24° C. temperature. The methanol reactor, the rectifying column and the tank are inertized with purified nitrogen. Prior to the start, in the heat exchanger containing the molten tin serving the accelerated start, electric heat ensures the complete melting of the load.

The electrolysis is initiated by using of 10.5 MW electric performance. As a result of the electrolysis 200 kg/hour hydrogen at 30 bar pressure and 50° C. temperature and 1600 kg/hour oxygen at 30 bar pressure and 50° C. temperature are produced. The oxygen is led to tanks established to this purpose of use. The hydrogen is heated for 10 minutes in the heat-exchanger containing molten tin, then by making use of the heat exchange of the methanol reactor, the hydrogen is heated to 210° C., and the above specified material stream is led to the methanol reactor. The carbon dioxide is in the first step compressed to 30 bar pressure and transferred to a tank of 2 ton capacity. Then it is heated to −6° C. making use of the ambient air with a lamellar heat exchanger and a blower, while leading the carbon dioxide to another 2 ton storage tank. The mass stream is 1467 kg/h. Then the liquid carbon dioxide is used for the production of cooling water, then it is heated for 10 minutes in a heat exchanger containing molten tin, than it is heated to 210° C. using the heat exchanger of the methanol reactor, and the gas thus obtained is led to the methanol reactor in the same mass stream.

As a result of the reaction taking place in the methanol reactor 1655 MJ/h reaction heat is generated, from which 435 MJ/h can be used for the pre-heating of the hydrogen, and 630 MJ/h can be used for the pre-heating of the carbon dioxide. By using of two grade heat exchangers 500 MJ/h heat may be used in ORC system for the energy supply of the auxiliary systems.

The steams generated contain 1066 kg/h methanol and 600 kg/h water. The steams are used for the heating of the boiler of the rectifying system, there maintaining a temperature of 102° C. The material is expanded to a pressure of 1.2 bar and led into the rectifying column. The head steam is condensed by the cold water obtained at the heating of carbon dioxide, and the methanol with quality needed for the supply of the gas turbine is ensured by the setting of the reflux.

Using model CX501-KB7 Rolls-Royce as a gas turbine 1.76 MWₑ and 3.03 MWₜₕ energy is obtained back by the use of the produced methanol. The oxygen produced replaces the consumption of 0.763 MW/h energy.

The total energy gain: 5.55 MW/h; efficiency: 52.8%

The model MAN Turbo methanol fuel gas turbine with 8.39 MW capacity is proven to present 9 USD cent/kWh saving as compared to the conventional fuels (Trinidad and Tobago), and the gas component emissions burdening the environment dramatically decrease. Further energy saving may be achieved by the establishment of the electric power storage plant near a plant using CCS technology, thus liquidization and the pressing of the liquid carbon dioxide under the ground or the sea may be saved. Using a pure carbon technology, the oxygen produced may also be used on the spot.

What is claimed is:

1. A system suitable for both of the production of electricity, and the utilization of electricity, which can flexibly be switched between said functions, and can be started quickly, said system comprising the following elements: electricity input (1) transformer-rectifier unit (2), which lead to an alkaline water electrolysing (decomposing) equipment (3) linked to a fresh water inlet (5), an oxygen storage and drawer unit (4) linked to the water electrolysis equipment (3), a hydrogen gas transmission unit (6) linked to the water electrolysis equipment (3), a reactor for the production of methanol (7), to which a carbon dioxide storage tank (8) and a carbon dioxide compressing and pre-heating unit (9) is linked at the input side, and a methanol-water rectifying unit (10) is linked at the output side, the water leaving said rectifying unit (10) is transferred to the fresh water inlet (5), and a unit that enables the separated methanol to be transferred to the methanol storage tank (11), which is optionally linked to an equipment suitable for the combustion of methanol, preferably gas turbine.

2. The system as claimed in claim 1, which may be switched between the electricity production and the electricity consumption functions, and/or started within less than 1 hour, preferably approximately 5 minutes.

3. The system as claimed in claim 1, in which the water electrolysis takes place at approximately 30 bar pressure.

4. The system as claim in claim 1, in which the reactor for the preparation of methanol (7) is equipped with a heat exchange unit, such that said heat storage unit can provide the 210° C. reactant temperature necessary for the production of methanol within 1 hour, preferably in approximately 5 minutes, and can store the production heat of methanol.

5. The system as claimed in claim 1, in which the reactor for the preparation of methanol (7) is equipped with a heat exchange unit, such that said heat storage unit can provide the heat transfer for the heating of carbon dioxide.

6. The system as claimed in claim 1, in which the alkaline water electrolysing (decomposing) equipment (3) further comprises the following elements: hydrogen gas preparing unit (26), molten tin starting pre-heater (26B), heat transfer from the methanol reactor (27), wherein the hydrogen gas preparing unit (26) receives the heat needed for its operation from the methanol reactor (7, 28).

7. The system as claimed in claim 1, in which the carbon dioxide storage tank (8) and the carbon dioxide compressing and pre-heating unit (9) further comprises the following elements: a liquid carbon dioxide storage tank (31), a liquid carbon dioxide compressing unit (32), an intermediary tank (33) for storing the carbon dioxide with elevated pressure, a lamellar heat-exchanging unit (35), a blower (37) for the heating of carbon dioxide, and a carbon dioxide pre-heating unit with continuous operation (42), and a molten tin starting carbon dioxide pre-heating unit (42B) placed within said carbon dioxide pre-heating unit.

8. The system as claimed in claim 1, in which the methanol-water mixture separation unit (10) comprises the following: rectifying column (53), boiler (51), expansion valve (52) and reflux cooler and distributor (54).

9. A process for storing electricity, wherein the following steps are taken:
a) the electricity is produced by a method known in itself;
b) hydrogen gas is produced using electricity by a method known in itself, preferably by water electrolysis;
c) if needed, carbon dioxide, preferably carbon dioxide obtained as a by-product from the combustion of fossils is pre-treated, and said carbon dioxide is reacted with the hydrogen gas prepared in step b) to produce methyl alcohol;
d) the methyl alcohol-water mixture is separated without using external heat source;
e) optionally the product according to step c) is combusted, preferably using gas turbine or combustion engine, thus electricity is produced;
f) optionally the oxygen gas produced in the reaction according to step c) is captured and thus electricity is saved.

10. The process as claimed in claim 9, wherein in step a) the electricity used is that part of the produced electricity, which cannot be used, or cannot be used economically in the electric energy system.

11. The process as claimed in claim 9, wherein the water electrolysis is performed such that the gas produced has approximately 30 bar pressure.

12. The process as claimed in claim 9, wherein the following steps are taken:
a) using the electricity of the electric network inlet (1), with the help of a transformer-rectifier unit (2), hydrogen (6) is produced in an alkaline water electrolysis system;
b) the hydrogen is led to the methanol reactor (7) after pre-treatment;
c) the oxygen (4) produced in the electrolysis resulting in water decomposition is led to a storage tank;
d) the water supply of the water electrolysis system is ensured together by the fresh water obtained from the water pre-treatment unit (5) and the return water leaving the methanol-water rectifying unit (10);
e) in the methanol reactor carbon dioxide, the other reactant besides hydrogen, is supplied from liquid carbon dioxide storing unit (8) using a compression and heating unit (9);
f) the methanol-water mixture produced in the methanol reactor (7) is separated in the rectifying unit, from where the methanol is transferred to the container (11).

13. The process as claimed in claim 9, wherein in the production and pre-treatment of hydrogen the following steps are taken:
a) after the electric network supply (21) and rectification (22) the produced oxygen is led from the electrolysis unit to the oxygen storing unit (24);
b) the hydrogen stream (25) produced in the water electrolysis is led to the heat exchanger (26) at a pressure of 30 bar, where, using a part of the methanol reaction heat (27), said hydrogen is heated to 210° C. temperature;
c) in the phase of the accelerated start the fast heating of the gas stream is ensured by molten tin in the (26B) part of the pre-heating unit;
d) the methanol-water system produced in the methanol reactor (28) is transferred to the methanol-water rectifying system; and optionally
e) a part of the heat generated (30) is used for the pre-heating of the carbon dioxide.

14. The process as claimed in claim 9, wherein in the carbon dioxide pre-treatment the following steps are taken:
a) the pressure of carbon dioxide stored in the liquid carbon dioxide storage tank (31), preferably at a pressure of 19 bar and at −24° C. is increased to approximately 30 bar, preferably using liquid carbon dioxide compressor;
b) if needed, the carbon dioxide with increased pressure is stored in the intermediary tank (33) for indefinite period of time;
c) the carbon dioxide is heated preferably to a temperature of −6° C., preferably in a lamellar heat exchanger unit (35), with the use of the ambient air and preferably with a blower (37), while maintaining the pressure of 30 bar;
d) if needed, the cold energy (38) is used in other points of the system;
e) in the phase of the accelerated start the fast heating of the gas stream is ensured by molten tin in the (42B) part of the pre-heating unit;
f) the carbon dioxide is heated to the temperature of 210° C. in the heat exchanger (42), in continuous operation, using a part of the reaction heat of methanol (44);
g) the pre-treated carbon dioxide is led to the methanol reactor (39), to where hydrogen is also fed (40);
h) if needed, the carbon dioxide is pre-heated with partial methanol-water stream (43), and in the heat exchanger (42) the partially cooled methanol-water mixture is led to the rectifying system.

15. The process as claimed in claim 9, wherein in the separation of the methanol-water mixture the following steps are taken:
a) with the liquid mixture (50) used in part for the pre-heating of hydrogen, in part for the pre-heating of carbon dioxide, said liquid mixture cooled to 170° C., but being of 30 bar pressure, the temperature of the boiler (51) is maintained at 102° C., then it is expanded to 1.2 bar pressure using the expansion valve (52)
b) leading the steam-liquid mixture to the rectifying column (53), the metanol steams are led to the reflux cooler (54), where with the help of the stream of the cooling water (58) it is condensed, and the produced methanol (55) is led at a pressure of 1.1 bar off;
c) the pure water leaving the boiler (56) is fed back the electrolysing system (57).

16. The process as claimed in claim 9, wherein in the pre-treatment of hydrogen gas, at the starting phase of the system's operation, the temperature of methanol needed in the reactor, preferably 210° C. is ensured by the use of a heat exchanger containing molten tin (26B), while in the continuous operation said temperature is ensured by the use of the reaction heat of methanol (26).
